(19) United States
(12) Patent Application Publication
(10) Pub. No.: US 2023/0400354 A1
(43) Pub. Date: Dec. 14, 2023

(54) PHOTONIC INTEGRATED CIRCUIT

(71) Applicant: ROCKLEY PHOTONICS LIMITED, Altrincham, Cheshire (GB)

(72) Inventor: Richard GROTE, Rancho Cucamonga, CA (US)

(21) Appl. No.: 18/035,271

(22) PCT Filed: Nov. 4, 2021
(86) PCT No.: PCT/EP2021/080649

§ 371 Date: May 3, 2023

Related U.S. Application Data
(60) Provisional application No. 63/110,909, filed on Nov. 6, 2020.

(30) Foreign Application Priority Data
Dec. 14, 2020 (GB) 2019693.7

(51) Int. Cl. G01J 3/453; G01S 17/894; G01J 3/28; G01S 7/481

(52) U.S. Cl. CPC G01J 3/4531; G01S 17/894; G01J 3/2823; G01S 7/4817; G01S 7/4815; G01S 7/4816; G01J 2003/2826

(57) ABSTRACT

A photonic integrated circuit for use in hyperspectral spectroscopy. The photonic integrated circuit comprising: a multi-spectral laser source, configured to produce a multi-spectral optical signal; a modulator, the modulator configured to split the multi-spectral optical signal into a first component and a second component, and apply an up-chirp modulation profile to the first component and a down-chirp modulation profile to the second component; a first transmitter and receiver module, configured to transmit the modulated first component and receive reflections of the first component; and a second transmitter and receiver module, configured to transmit the modulated second component and receive reflections of the second component.

### FIELD OF THE INVENTION

The present invention relates to a photonic integrated circuit.

### BACKGROUND

Coherent optical measurements, commonly used for LiDAR and remote sensing, rely on swept-laser interferometer whereby the wavelength of a laser, for example a DBR laser, is linearly chirped. This chirping can be achieved either by an external cavity, direct modulation of the drive current of the laser, or an electro-optic IQ modulator driven with the appropriate RF waveform (see, e.g. Gao et al., 2012).

The swept source is then split between two paths, one of which contains a target that reflects and scatters incident light and so returns a weak probe beam. This weak probe beam is mixed with the light in the other split path (referred to as the local oscillator or LO) to create a measurable beat tone signal at RF or microwave frequencies. Examples of this type of measurement performed using silicon photonic devices integrated circuit includes frequency modulated continuous wave LiDAR (Poulton et al., 2016) and optical coherence tomography (Schneider et al., 2016).

However, it would be advantageous to provide a packable silicon photonic integrated circuit which can be more readily applied in an integrated multichannel coherent photometer.

### SUMMARY

Accordingly, in a first aspect, embodiments of the present invention provide a photonic integrated circuit, for use in hyperspectral spectroscopy, the photonic integrated circuit comprising:
a multi-spectral laser source, configured to produce a multi-spectral optical signal;
a modulator, the modulator configured to split the multi-spectral optical signal into a first component and a second component, and apply an up-chirp modulation profile to the first component and a down-chirp modulation profile to the second component;
a first transmitter and receiver module, configured to transmit the modulated first component and receive reflections of the modulated first component; and
a second transmitter and receiver module, configured to transmit the modulated second component and receive reflections of the modulated second component.

The photonic integrated circuit enables hyperspectral absorption/scattering spectroscopy of targets (e.g. biological tissue). This spectroscopy can be performed in in the near infrared. The circuit boosts the minimum detectable power of a photometric detector using coherent detection.

The photonic integrated circuit may have any one, or any combination insofar as they are compatible, of the following optional features.

The modulator may be a dual single-side band modulator. The dual single-side band modulator may comprise a pair of Mach-Zehnder interferometers, each Mach-Zehnder interferometer containing a pair of phase modulators. Each Mach-Zehnder interferometer may contain one or more heaters.

The multi-spectral laser source may comprise a plurality of single frequency lasers, the single frequency lasers being connected to a wavelength multiplexer which provides the multi-spectral optical signal.

The multi-spectral laser may comprise a tunable laser source.

The multi-spectral laser may comprise a single frequency laser and a tunable external cavity.

The lasers may be Distributed Bragg Reflector (DBR) lasers.

One or both of the transmitter and receiver modules may comprise a Mach-Zehnder interferometer, comprising a first arm and a second arm, wherein:
the first arm of the Mach-Zehnder interferometer connects the modulator to the transmission facet; and
the second arm of the Mach-Zehnder interferometer connects:
   the modulator to a coupling region; and
   a receiving facet to the coupling region;
and wherein the coupling region is configured to mix the respective modulated component and reflections of the respective modulated component, and provide the mixed signal to a first and second photodiode.

One or both of the transmitter and receiver modules may comprise a Michelson interferometer, the Michelson interferometer comprising a first waveguide and a second waveguide, wherein the first waveguide connects the modulator to an input and output facet, and the second waveguide connects a mirror to a photodiode, the first and second waveguides are coupled at a coupling region between the mirror and photodiode.

The up-chirp modulation profile and down-chirp modulation profile may be linear chirp modulation profiles.

The up-chirp modulation profile and down-chirp modulation profile are in the radio frequency range. The up-chirp modulation profile and down-chirp modulation profile may be at least 1 GHz and no more than 40 GHz.

The first transmitter and receiver module and/or the second transmitter and receiver module may be connected to a master control unit via an amplifier.

In a second aspect, embodiments of the invention provide a spectroscope system architecture, including a plurality of the photonic integrated circuits of the first aspect in an array.

In a third aspect, embodiments of the invention provide a hyperspectral spectroscope, comprising a plurality of the photonic integrated circuits of the first aspect in an array, the array being mounted on a scanning galvometer, wherein the modulated first and second components of each photonic integrated circuit are directed into one or more telecentric lenses, the spectroscope being configured to produce a hyperspectral confocal image.

The photonic integrated circuits of the third aspect may have any one, or any combination insofar as they are compatible, of the optional features of the first aspect.

In a fourth aspect, embodiments of the present invention provide a method of hyperspectral spectroscopy, using the spectroscope of the third aspect.

In a fifth aspect, embodiments of the present invention provide a LiDAR imaging device, comprising a plurality of the photonic integrated circuits of the first aspect in an array, the array being mounted on a scanning galvometer, wherein the modulated first and second components of each photonic integrated circuit are directed into a collimating micro-lens, the LiDAR imaging device being configured to produce a point cloud.

The photonic integrated circuits of the fifth aspect may have any one, or any combination insofar as they are compatible, of the optional features of the first aspect.

In a sixth aspect, embodiments of the present invention provide a method of LiDAR imaging using the LiDAR imaging device of the fifth aspect.

Further aspects of the present invention provide: a computer program comprising code which, when run on a computer, causes the computer to perform the method of the fourth or sixth aspect; a computer readable medium storing a computer program comprising code which, when run on a computer, causes the computer to perform the method of the fourth or sixth aspect; and a computer system programmed to perform the method of the fourth or sixth aspect.

### BRIEF DESCRIPTION OF THE DRAWINGS

Embodiments of the invention will now be described by way of example with reference to the accompanying drawings in which:

FIG. 1 shows a photonic integrated circuit according to the present invention;

FIGS. 2A and 2B show respective implementations of a multi-spectral laser source used in the circuit of FIG. 1;

FIG. 3 is a schematic of a dual single-side band modulator used in the circuit of FIG. 1;

FIGS. 4A and 4B show respective implementations of the first and/or second transmitter and receiver module used in the circuit of FIG. 1;

FIG. 5 shows a spectroscope system architecture, including a plurality of the circuits of FIG. 1 in an array;

FIG. 6 shows a hyperspectral spectroscope using the system architecture of FIG. 5; and

FIG. 7 shows a LiDAR imaging device using the system architecture of FIG. 5.

### DETAILED DESCRIPTION AND FURTHER OPTIONAL FEATURES

Aspects and embodiments of the present invention will now be discussed with reference to the accompanying figures. Further aspects and embodiments will be apparent to those skilled in the art. All documents mentioned in this text are incorporated herein by reference

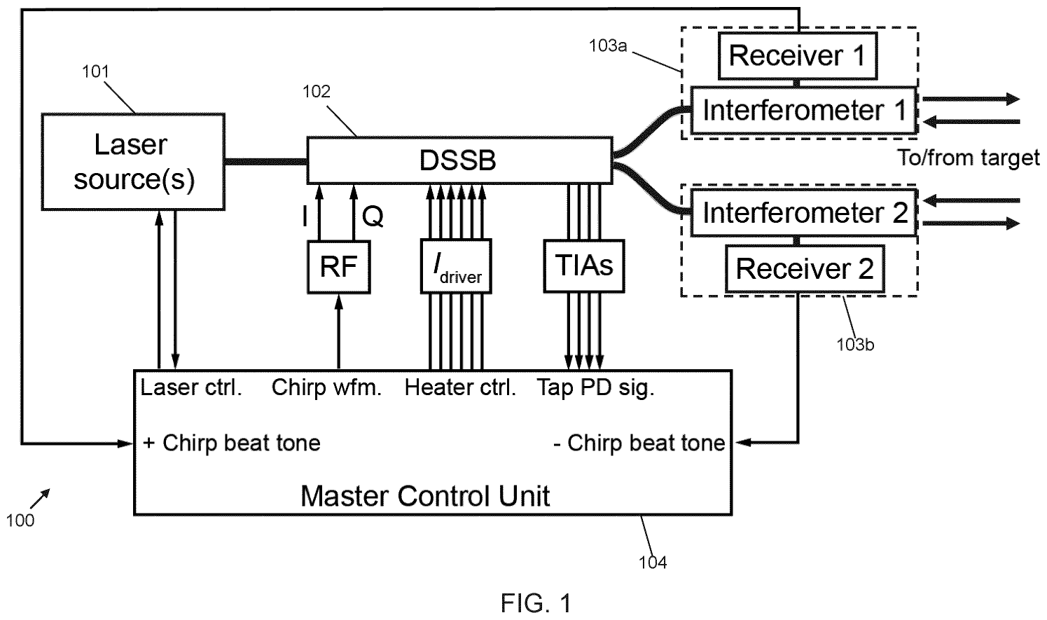

FIG. 1 shows a photonic integrated circuit 100. The circuit includes a multi-spectral laser source 101, which is configured to produce a multi-spectral optical signal. The laser source 101 is connected to a dual single-side band, DSSB, modulator 102. The DSSB modulator splits the signal received from the laser source 101 into a first component and a second component. It then applies an up-chirp modulation profile to the first component and a down-chirp modulation profile to the second component. The first component is then provided to a first transmitter and receiver module 103a, whereas the second component is provided to a second transmitter and receiver module 103b. Each transmitter and receiver module comprises an interferometer and a receiver, which is connected to the interferometer.

The circuit 100 also includes a master control unit, MCU, 104. The MCU is configured to control the laser sources by providing appropriate control signals (discussed in detail below). For example, for a tunable laser the MCU would provide a driving current which also serves to select the frequency of the laser. The MCU is also connected to the DSSB, and provides the chirp waveform from which the modulation profiles are generated. In this example, the master control unit provides the chirp waveform to an RF generator, which provides I and Q values (indicative of magnitude and phase) to the DSSB 102. The MCU also provides driving currents, I_{driver}, to one or more heaters within the DSSB. The DSSB contains one or more photodiode taps, which provide an indication of the power of various optical signals within the DSSB. These taps are connected to respective transimpedance amplifiers (TIAs) which provide tap photodiode signals to the MCU. The MCU 104 is also connected to each of the first and second transmitter and receiver modules 103a and 103b. Therefore it receives an up-chirp beat tone from the first transmitter and receiver module and a down-chirp beat tone from the second transmitter and receiver module. The MCU can thereby perform coherent detection and so facilitate hyperspectral spectroscopy.

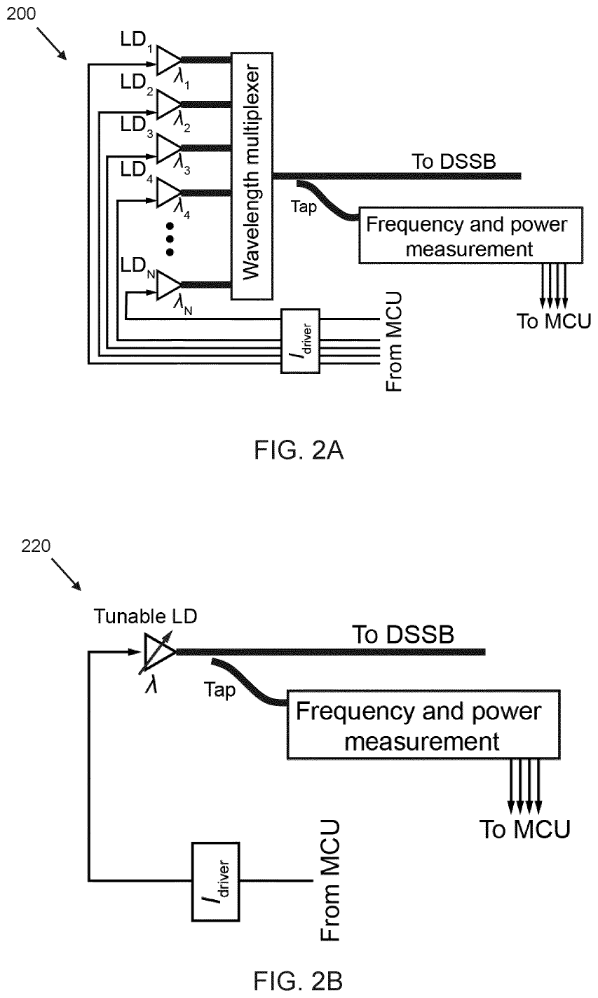

FIGS. 2A and 2B show respective implementations of a multi-spectral laser source used in the circuit of FIG. 1. In the laser source 200 shown in FIG. 2A, a plurality of single frequency stabilized Distributed Bragg Reflector (DBR) lasers: LD₁-LDₙ. n may take a value of at least 128. Each laser La provides light at a wavelength λᵢ when driven at a driving current I_{driver} received from the MCU. The outputs from each of the lasers are provided into a wavelength multiplexer, which combines the outputs into a single optical signal. This multiplexed optical signal is provided to the DSSB via an output waveguide, with a tap being taken to measure the frequency and power of the multiplexed optical signal. These measurements are provided to the MCU.

In the laser source 220 shown in FIG. 2B, a single frequency-tunable DBR is provided. The frequency-tunable DBR provides an optical signal at a wavelength A which is at least partially determined by the driving current I_{driver} provided by the MCU. This optical signal is provided to the DSSB via an output waveguide, with a tap being taken to measure the frequency and power of the optical signal. This measurement is provided to the MCU.

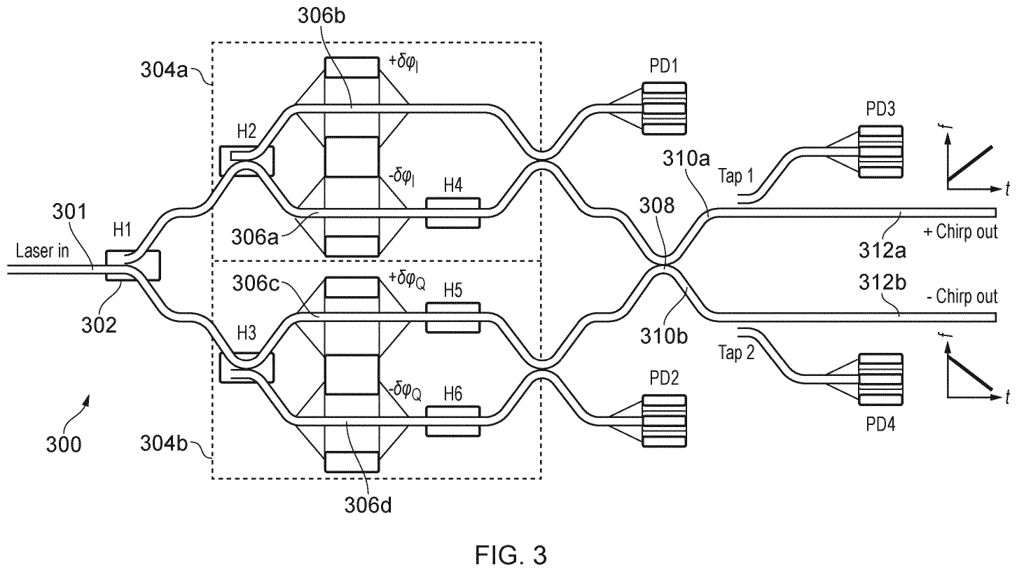

FIG. 3 is a schematic of a dual single-side band, DSSB, modulator 300 used in the circuit of FIG. 1. The DSSB can be considered as comprising two Mach-Zehnder interferometers 304a and 304b, which each receive a portion of the laser light signal provided at an input 301. The laser light signal is split by splitter 302, at a ratio of 50:50. The first Mach-Zehnder interferometer, MZI, 304a includes a pair of phase modulators 306a and 306b, and the second Mach-Zehnder interferometer 304b also includes a pair of phase modulators 306c and 306d. The phase modulators can be a combination of electro-optic or free carrier phase shifters, and are driven at the appropriate RF frequency and modulation index. A given phase modulator of each pair of phase modulators is driven out of phase, and such that each MZI is operated as an amplitude modulator (also known as an MZI modulator). The drive amplitude of each of the MZI modulators is selected to produce a suppressed-carrier amplitude modulation profile, and the drive signals of the two MZI modulators are selected to have a phase difference of 90°, so that the amplitude modulation produced by one MZI modulator is 90° out of phase with the amplitude modulation produced by the other MZI modulator. The effect of the phase difference is that, for example, when the two first sidebands (the first upper sideband and the lower first sideband (which, referenced to the input light, have phases rotating in opposite directions at the modulation frequency)) produced by the first MZI modulator are in phase with each other, the two first sidebands of the second MZI modulator have opposite phases. The drive voltage on the phase modulators, in this instance IQ phase modulators, is controlled so as to linearly chirp the received laser signal in the range of 1 GHz to 40 GHz at each received wavelength.

The two amplitude modulated signals are combined in a combiner 308. If the optical delays from each MZI modulators to the combiner 308 are suitable chosen, constructive interference will occur at a first output 310a for one of the sidebands (in this example the up-chirped sideband). Because the down-chirped sidebands are out of phase when the up-chirped sidebands are in phase, they destructively interfere at the first output 310a of the combiner 308 and therefore interfere constructively at a second output 310b of the combiner 308. The up-chirp sideband (+Chirp out) and down-chirp sideband (−Chirp out) can thereby be provided through separate output waveguides 312a and 312b respectively.

In this, and other, embodiments, active control is used to control the optical phase difference of the two amplitude modulated optical signals arriving at the combiner 308. For example, the temperature may be actively stabilized using a temperature sensors and one or more heaters: H1-H6. Further, in this embodiment, a 2×2 coupler is provided between each MZI modulator and the coupler 308. Therefore each MZI modulator has two outputs (carrying complementary signals), one of which is connected to the combiner 308. The other output of each MZI modulator may be used as feedback for tuning the RF drive signal and/or thermal tuners, for example by provision to a photodiode (PD1 or PD2). Alternatively, instead of a 2×2 coupler, each MZI may be provided with a Y-coupler and so provide only a single output. Further, a tap is taken from each of the first 310a and second 310b outputs and provided to respective photodiodes PD3 and PD4. The signals from these are provided to the MCU, so that further tuning can be performed.

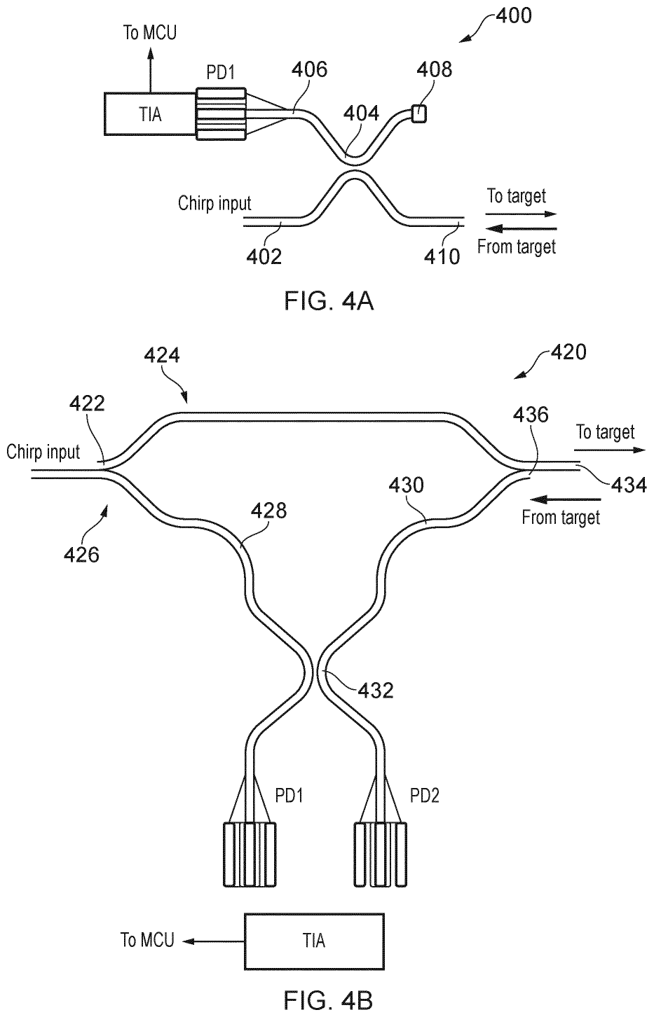

FIGS. 4A and 4B show respective implementations 400 and 420 of the first and/or second transmitter and receiver module used in the circuit of FIG. 1. The first implementation 400, shown in FIG. 4A, is a Michelson interferometer. A chirp input (one of the modulated first or second components) is provided to an input of a first waveguide 402. This chirp input is then carried to a coupling region 404, and a portion of the chirp input is coupled into a second waveguide 406 to provide the local oscillator. The remaining portion of the chirp input is transmitted to the target via an output facet 410, and reflection from the target are received back into the same facet. The reflections from the target are then coupled into the second waveguide 406 at the coupling region, where it mixes with the reflection of the local oscillator (the local oscillator signal having reflected from a broadband mirror 408 located at the end of the second waveguide). The mixed signal is then provided to a photodiode PD1, which converts the mixed signal to photocurrent. This photocurrent is amplified via a TIA, and then provided to the MCU for analysis.

FIG. 4B shows a second implementation 420, which is a Mach-Zehnder interferometer, MZI. The chirp input is provided to an input 422 of the MZI, which splits the signal into a first arm 424 and second arm 426 of the MZI. The first arm 424 connects to an output facet 434, through which the chirped signal is transmitted to the target. The second arm 426, carrying the local oscillator, comprises two waveguides: a first waveguide 428 and a second waveguide 430. The first waveguide connects the input 422 of the MZI to a first photodiode PD1 via a coupling region 432. The second waveguide connects an input facet 436, through which reflections from the target are received, to a second photodiode PD2 via the same coupling region 432. Therefore in the coupling region 432 the local oscillator mixes with the received signal as before. The mixed signal is then provided to both PD1 and PD2 for conversion into photocurrent. The photocurrent is again amplified via a TIA, and provided to the MCU for analysis.

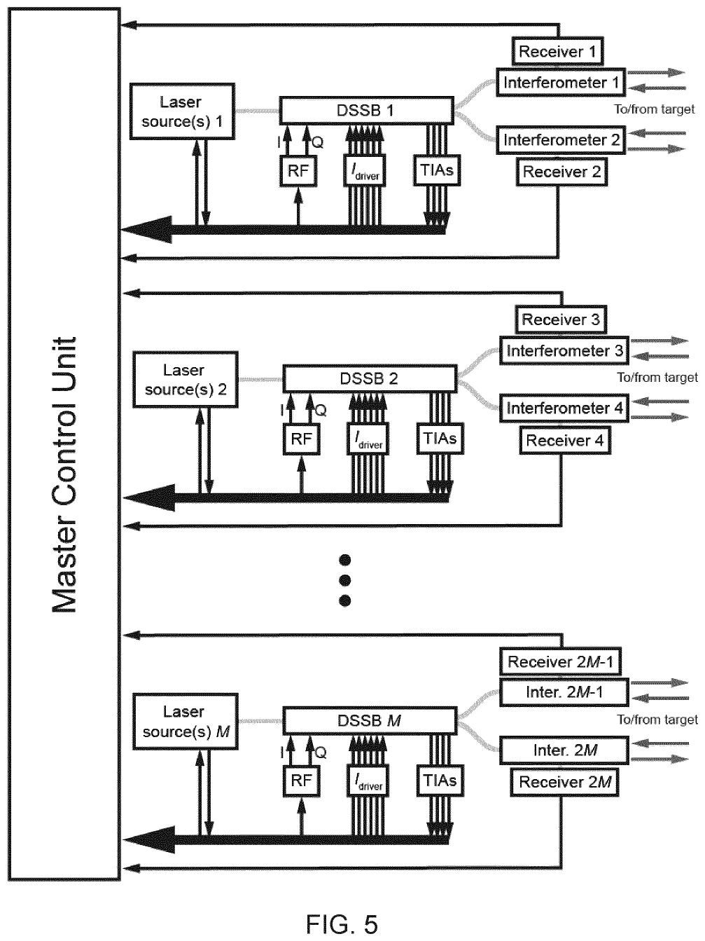

FIG. 5 shows a spectroscope system architecture, including a plurality of the circuits 100 of FIG. 1 in an array. Each circuit 100 provides two channels, the frequency of which can be controlled by a single MCU. The MCU is connected to and controls each of the circuits 100. In the example shown, there are M circuits and so the architecture is capable of imaging at 2M channels. M may have a value of at least 128.

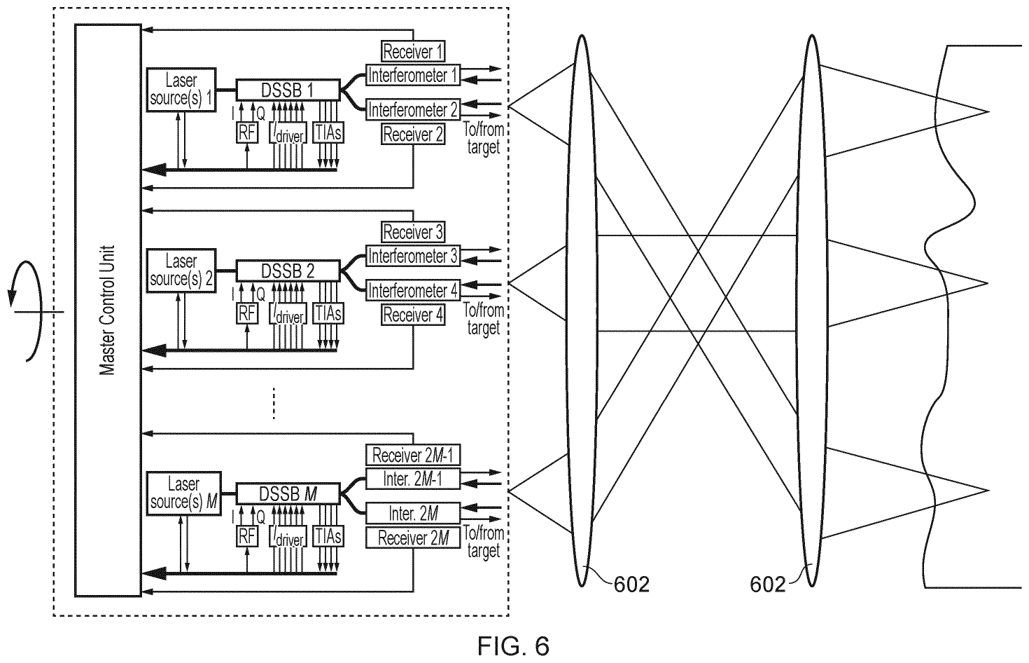

FIG. 6 shows a hyperspectral spectroscope using the system architecture of FIG. 5. The array of circuits 100 is mounted on a single-axis scanning galvanometer, and the outputs of each circuit are provided through one or more telecentric lenses 602. This allows hyperspectral imaging of a sample.

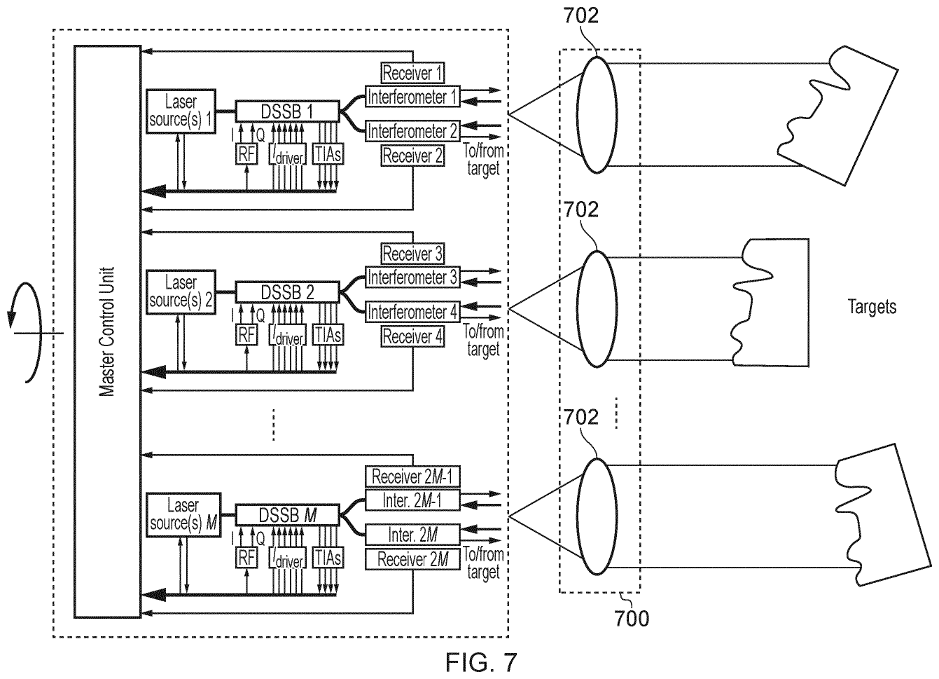

FIG. 7 shows a LiDAR imaging device using the system architecture of FIG. 5. The array of circuits 100 are again mounted on a single-axis scanning galvanometer, whilst in this instance the outputs of each circuit are focused through respective collimating microlenses 702 provided as a collimating microlens array 720. This allows for the generation of a LiDAR point cloud.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

### REFERENCES

S. Gao and R. Hui, Opt. Lett., 37 (2012)
C. V. Poulton et al., W4E.3 OFC (2016)
S. Schieider et al., Opt. Express 24 (2016)

1. A photonic integrated circuit, for use in hyperspectral spectroscopy, the photonic integrated circuit comprising:
a multi-spectral laser source, configured to produce a multi-spectral optical signal;
a modulator, the modulator configured to split the multi-spectral optical signal into a first component and a second component, and apply an up-chirp modulation profile to the first component and a down-chirp modulation profile to the second component;
a first transmitter and receiver module, configured to transmit the modulated first component and receive reflections of the modulated first component; and
a second transmitter and receiver module, configured to transmit the modulated second component and receive reflections of the modulated second component.

2. The photonic integrated circuit of claim 1, wherein the modulator is a dual single-side band modulator.

3. The photonic integrated circuit of claim 2, wherein the dual single-side band modulator comprises a pair of Mach-Zehnder interferometers, each Mach-Zehnder interferometer containing a pair of phase modulators.

4. The photonic integrated circuit of claim 3, wherein each Mach-Zehnder interferometer contains one or more heaters.

5. The photonic integrated circuit of claim 1, wherein the multi-spectral laser source comprises a plurality of single frequency lasers, the single frequency lasers being connected to a wavelength multiplexer which provides the multi-spectral optical signal.

6. The photonic integrated circuit of claim 1, wherein the multi-spectral laser source comprises a tunable laser source.

7. The photonic integrated circuit of claim 1, wherein the multi-spectral laser source comprises a single frequency laser and a tunable external cavity.

8. The photonic integrated circuit of claim 1, wherein one or both of the transmitter and receiver modules comprises a Mach-Zehnder interferometer, comprising a first arm and a second arm, wherein:
the first arm of the Mach-Zehnder interferometer connects the modulator to a transmission facet; and
the second arm of the Mach-Zehnder interferometer connects:
the modulator to a coupling region; and
a receiving facet to the coupling region;
and wherein the coupling region is configured to mix the respective modulated component and reflections of the respective modulated component, and provide the mixed signal to a first and second photodiode.

9. The photonic integrated circuit of claim 1, wherein one or both of the transmitter and receiver modules comprises a Michelson interferometer, comprising a first waveguide and a second waveguide, wherein the first waveguide connects the modulator to an input and output facet, and the second waveguide connects a mirror to a photodiode, and the first and second waveguides are coupled at a coupling region between the mirror and photodiode.

10. The photonic integrated circuit of claim 1, wherein the up-chirp modulation profile and down-chirp modulation profile are linear chirp modulation profiles.

11. The photonic integrated circuit of claim 1, wherein the up-chirp modulation profile and down-chirp modulation profiles are in the radio frequency range.

12. The photonic integrated circuit of claim 1, wherein the first transmitter and receiver module and/or the second transmitter and receiver module are connected to a master control unit via an amplifier.

13. A spectroscope system architecture, including a plurality of the photonic integrated circuits of claim 1 in an array.

14. A hyperspectral spectroscope, comprising a plurality of the photonic integrated circuits of claim 1 in an array, the array being mounted on a scanning galvanometer, wherein the modulated first and second components of each photonic integrated circuit are directed into one or more telecentric lenses, the spectroscope being configured to produce a hyperspectral confocal image.

15. A method of hyperspectral spectroscopy, performed using the spectroscope of claim 14.

16. A LiDAR imaging device, comprising a plurality of the photonic integrated circuits of claim 1 in an array, the array being mounted on a scanning galvanometer, wherein the modulated first and second components of each photonic integrated circuit are directed into a collimating micro-lens, the LiDAR imaging device being configured to produce a point cloud.

17. A method of LiDAR imaging, performed using the LiDAR imaging device of claim 16.
